(19) United States
(12) Patent Application Publication
(10) Pub. No.: US 2004/0008582 A1
(43) Pub. Date: Jan. 15, 2004

(54) Rental appliance hiring system

(76) Inventors: Alan Robert Richards, Queensland (AU); Tracy Lyn Richards, Queensland (AU)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 10/297,191

(22) PCT Filed: Jun. 14, 2001
(86) PCT No.: PCT/AU01/00703

(30) Foreign Application Priority Data
Jun. 15, 2000 (AU) 40883/00

(51) Int. Cl. G04B 47/00

(52) U.S. Cl. 368/10

(57) ABSTRACT

A powered rental appliance which has a power cut off switch, a timer which is preset to a hiring period prior to the appliance being hired to a hiree, display means to display the hire time remaining, and means to reset the timer upon payment of an additional hire charge to the hirer, whereby the cut off switch is activated after the preset hire period has been exceeded without an additional hire charge having been paid to the hirer.

### FIELD OF THE INVENTION

This invention relates to a rental appliance (or apparatus) hiring system which encourages a person hiring the appliance (the hiree) to keep abreast of rental charges.

The invention will be described with reference to an appliance such as an air-conditioning unit, but it should be appreciated that the invention is applicable to other types of appliances or other devices which are rented, hired, or leased and which require periodic payments.

### BACKGROUND ART

Businesses which hire out products to customers often have difficulties in ensuring that the products are returned within the hire period. If not, the business levies extra hiring charges or penalties. Often, the customer feels disinclined to pay any penalty charges resulting in a dispute.

Certain types of rented products are electrically powered and these can include larger airconditioning units, fans and blowers, and electrically operated equipment such as cement mixers. Other products are powered by petrol or diesel motors.

These products invariably attract a higher hiring charge and the charge is usually by the hour, day, week, and the like. Because of the higher hiring charge (and the greater expense in purchasing and maintaining the products), profits can be easily eroded if the product is not returned within the hire period.

It is known to provide certain types of equipment with a coin box associated with a timer. The coin box forms part of the equipment. A customer must keep inserting coins into the coin box to reset the timer or to increase the timed period. Examples of these include washing machines and dryers at laundromats, and airconditioners and heaters in low budget accommodation.

A disadvantage with this arrangement is that the coin box must be emptied frequently. The coin box can also be vandalised and broken into and it is common for a thief to have scant regard to the rest of the equipment which usually results in the equipment becoming damaged often beyond repair when the coin box is prised open or cut away from the equipment.

This known arrangement has a further disadvantage in that the person hiring the equipment (the hireor) loses contact with the equipment, and the hiree does not need to go back to the hireor as long as coins are fed into the coin box.

Another known system has a timer device that is attached to rental equipment in order to control the amount of time that the item of rental equipment can be used for. The device requires a magnetic card to be inserted into a magnetic card reader which forms part of the device. The magnetic card includes information such as the date and time of expiration of the rental period for the item of equipment. When the magnetic card is entered into the magnetic card reader, the device determines whether the rental period has expired by comparing the expiration date and time on the card with the current date and time provided by a real time clock in the device. When the date and time of the real time clock equals the date and time stored on the magnetic card, the device disables the item of equipment. In order to extend the rental period, the magnetic card must be removed from the device and returned to the rental agency for reprogramming. Alternatively, a new magnetic card must be obtained from the rental agency and inserted into the device. Thus, it can be appreciated that the need to reprogram the magnetic card or obtain a new magnetic card can result in an undesirable delay due to the transportation of a card or cards between the hirer and the hiree.

### OBJECT OF THE INVENTION

The present invention is directed to a powered rental appliance and a system which may overcome the abovementioned disadvantages or provide the public with a useful or commercial choice.

In one form, the invention resides in a powered rental appliance which has a power cut off switch, a timer which is preset to a hiring period prior to the appliance being hired to a hiree, display means to display the hire time remaining, and means to reset the timer upon payment of an additional hire charge to the hirer, whereby the cut off switch is activated after the preset hire period has been exceeded without an additional hire charge having been paid to the hirer.

In a more particular form there is described a powered rental appliance which has a power cut off switch, an electronic timer which is preset to a hiring period prior to the appliance being hired to a hiree, display means to display the hire time remaining, and means for enabling the timer to be reset substantially immediately upon payment of an additional hire charge to the hirer when the appliance is located remotely of the hirer, whereby the cut off switch is activated after the preset hire period has been exceeded without an additional hire charge having been paid to the hirer.

Suitably, the timer is associated with data input means, to input data such as a code reset the timer. The data input means may comprise a keypad on or associated with the appliance, a radio frequency or infrared data input means which includes a transmitter and a receiver, the receiver being associated with the appliance, an Internet link connected to the appliance to allow the code to be downloaded to the appliance, a data cable connection such as a telephone cable or other type of cable to enable the code to be transmitted to the appliance, a telephone line control, and a magnetic card (such as a telephone card containing electronic credit) inserted into a respective reader on or associated with the appliance. Thus, broadly, the timer maybe associated with a mechanical data input means such as a keypad, or a remote data entry means which requires some form of receiver on the appliance.

Suitably, the appliance has the timer associated with a keypad and the means to reset the timer is a non-reusable code which is punched into the keypad.

In another form, the invention resides in a rental system which comprises

a powered rental appliance,

a cut off switch to make the appliance unusable, a timer which is preset to a hiring period prior to the appliance being hired to a hiree, display means to display the hire time remaining, and means to reset the timer upon payment of an additional hire charge to the hirer, whereby the cut off switch is activated after the preset hire period has been exceeded without an additional hire charge having been paid to the hirer.

The arrangement as described above has the advantage of providing the hiree with continual feedback to the time remaining and the hiree cannot use the appliance after the expiry of the remaining time unless payment is given to the hireor.

The rental appliance is typically an electrically operated appliance such that the cut off switch can be placed in a tamper proof position to cut off the supply of electric power to the appliance. For instance, the cut off switch may comprise part of a plug pack such that the electric plug of an existing appliance can be attached in a non removable manner to the plug pack, and the plug pack can comprise the cut off switch, and optionally the data entry means such as a keypad and the like.

If the appliance is a petrol or diesel-type appliance, the cut off switch can be associated with any convenient part of the motor to cut off electrical supply to the spark plug (for a petrol motor), or the fuel supply (for a diesel motor). Other types of cut off arrangements can also be used.

The timer can be of any convenient type and is preferably one which has a visual display such that the hiree can constantly be informed of the rental time remaining. The timer may have a battery back up, and may comprise a microprocessor with a countdown timer.

The display means may be in the form of a liquid crystal or any other type of suitable display which may form part of the timer or be operatively associated by the timer. The display may be visual and/or audio.

A means is provided to reset the timer upon payment of an additional hire charge. In one form, the rental appliance can have or be associated with a keypad or other type of data entry device. A hiree may receive a password or code from the hireor upon payment of an extra hiring charge and this password or code can be entered into the keypad or data entry device to reset the timer. The password or code may be provided by telephone, by mail, by facsimile, by e-mail, via the Internet, or by any other suitable means.

If additional hire charge has not been made, the cut off switch is activated after the preset hire period has been exceeded.

When the appliance is initially rented, the timer is preset at the point of origin and can be preset to any agreed upon hiring period. If additional hiring charge is required, the hireor may provide a code or password to the hirer which the hiree can then punch into the keypad or data entry device to reset the timer. The password or code can be for different hiring charges to suit.

The timer reset code may be provided via a means other than a key pad or data entry device, and may include a receiver on or associated with the appliance to receive a code.

Funds can be transferred from the hiree to the hireor by credit card, direct payment, cheque, cash, or any other suitable financial transaction method.

The hireor may have “use once” passwords or codes. Thus, once the password or code has been entered into the appliance, the appliance will not accept the same password or code again.

### BRIEF DESCRIPTION OF THE DRAWINGS

An embodiment of the invention will be described with reference to the following figures in which:

FIG. 1. Illustrates a rental system according to an embodiment of the invention.

FIGS. 2A-2C. Illustrate front side and internal views of a keypad module according to an embodiment of the invention.

FIGS. 3A-B. Illustrate a plug pack holder according to an embodiment of the invention.

### BEST MODE

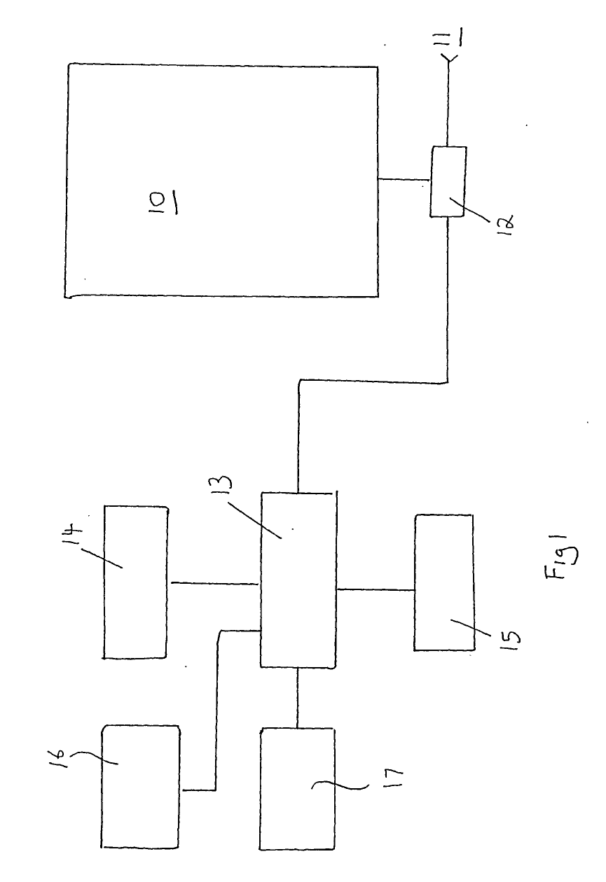

Referring to FIG. 1, there is illustrated generally a rental appliance 10. Rental appliance 10 in the embodiment is electrically powered via a power supply 11. Intermediate rental appliance 10 and power supply 11 is a power cut off switch 12 in the form of a relay. Electrically connected to cut off switch 12 is a microprocessor with a countdown timer 13. The microprocessor has a battery back up 14 and a memory code storage 15. The microprocessor 13 displays a countdown time to a display means 16 which can be visual but may also include an audio warning or display. A password or code can be entered into a microprocessor through a keypad 17.

The various components can be fitted within a power control module one face of which has the keypad 17 and the display means 16. The module can be attached somewhere convenient to the appliance.

In use, the hireor can set the timer to display unused and paid for time left. The hiree can be given a constant display or monitoring of the unused time (typically in hours or days) and allows the hiree to judge when to pay the next installment of hire cost.

It is found that the system encourages payment of hire fees before the timer switches off the power supply to the appliance.

When the hiree pays for additional hiring time, a non-reusable code is given which can be entered through keypad 17.

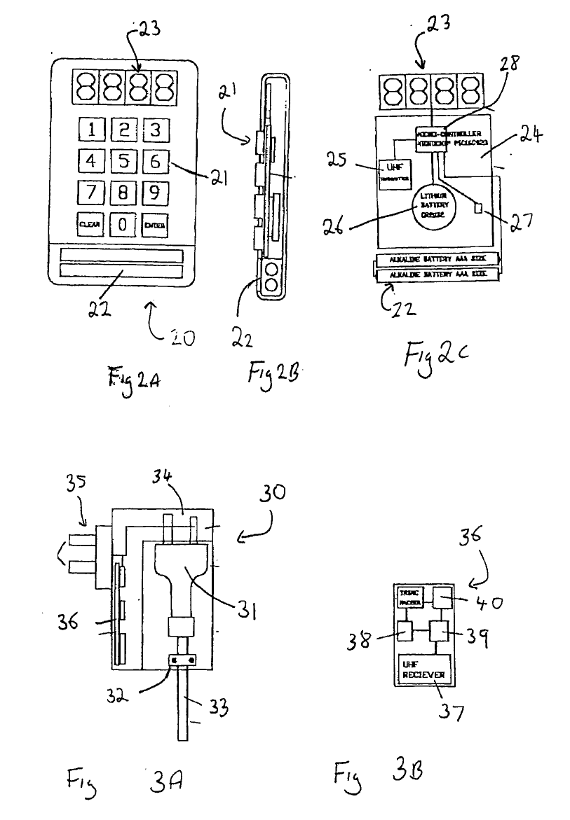

Referring to FIGS. 2A-C there is illustrated a keypad module attachable to a rental appliance or a rental device. Keypad module 20 is substantially rectangular when viewed in plan and contains a number of data entry buttons 21 which can be protected by a plastic (typically silicone plastic) cover. The keypad module 20 is powered by alkaline batteries 22 in the bottom of module 20, these batteries being in a separate compartments having a removable cover such that the batteries can be replaced when required. The upper part of module 20 has a four digit liquid crystal display 23 having a height of approximately 25 mm and a width of approximately 50 mm. The entire module has a width of approximately 55 mm, and a height of approximately 100-150 mm. The liquid crystal display 23 is formed separately and is joined to the main board 24 using a heat seal membrane. Board 24 supports a UHF receiver 25, a lithium battery 26, a infrared diode 27 for loading date and serial number, and a micro controller 28 with an onboard EEPROM memory chip.

FIGS. 3A-B illustrate a plug pack holder which is attached to the regular electrical plug of a rental appliance or device to allow the appliance or device to be used as part of the invention. Holder 30 accommodates the regular electrical plug 31 of the appliance or device. Plug 31 is attached to holder 30 in a non removable manner, and this can be achieved using a clamp or grip 32 to clamp or grip the plug cord 33. Plug 31 plugs into a socket 34 in the holder 30. An outer wall of holder 30 is provided with a regular plug arrangement 35 (which will vary depending on the country), and which can be plug into an electric power supply. Inside holder 30 is a control board 36 details of which are better illustrated in FIG. 3B. Control board 36 has a UHF receiver 37, a low voltage regulator 38, a micro controller with an onboard EEPROM 39, and an optical isolator 40.

The system acts as a prompt to encourage payment and it is found that it significantly increases profitability by ensuring prompt and advance payment of hiring charges.

It should be appreciated that various other changes or modifications can be made to the embodiment described without departing from the spirit and scope of the invention as claimed.

1. A powered rental apparatus which has a power cut off switch, an electronic timer which is preset to a hiring period prior to the apparatus being hired to a hiree, display means to display the hire time remaining, and means to reset the timer upon payment of an additional hire charge to the hirer, whereby the cut off switch is activated after the preset hire period has been exceeded without an additional hire charge having been paid to the hirer.

2. The apparatus of claim 1, comprising data input means associated with the timer, to input data such reset the timer, the data input means being selected from the group consisting of: a keypad on or associated with the apparatus, a radio frequency or infrared data input means which includes a transmitter and a receiver, the receiver being associated with the apparatus, an Internet link connected to the apparatus to allow the code to be downloaded to the apparatus, a data cable connection such as a telephone cable or other type of cable to enable the code to be transmitted to the apparatus, a telephone line control, and a magnetic card (such as a telephone card containing electronic credit) inserted into a respective reader on or associated with the apparatus.

3. The apparatus of claim 2, wherein the means for enabling the timer to be reset upon payment of an additional hire charge to the hirer is used when the apparatus is located remotely of the hirer.

4. The apparatus of claim 3, wherein the data inputted into the date entry means is a non-reusable code.

5. The apparatus of claim 4, wherein the code allows the timer to be reset substantially immediately.

6. The apparatus of claim 2, wherein the apparatus is electrically operated and the cut off switch is placed in a tamper proof position to cut off the supply of electric power to the apparatus.

7. The apparatus of claim 6, comprising a plug pack containing the cut off switch, the apparatus having an electric plug which is attached in a non-removable manner to the plug pack.

8. The apparatus of claim 7, wherein plug pack includes the date entry means.

9. The apparatus of claim 2, wherein a petrol or diesel engine powers the apparatus and the cut off switch cuts off the electrical supply to the spark plug (for a petrol motor), or the fuel supply (for a diesel motor).

10. The apparatus of claim 2, wherein the timer is preset at the point of origin the originally agreed upon hiring period.
